(19) United States
(12) Patent Application Publication
(10) Pub. No.: US 2013/0090978 A1
(43) Pub. Date: Apr. 11, 2013

(54) RISK-BASED EVALUATION OF FINANCIAL ADVISORS

(71) Applicants: Brenda Esperum Vaughn, Coon Rapids, MN (US); Brendan Moore Foote, Saint Paul, MN (US)

(72) Inventors: Brenda Esperum Vaughn, Coon Rapids, MN (US); Brendan Moore Foote, Saint Paul, MN (US)

(73) Assignee: Ameriprise Financial, Inc., Minneapolis, MN (US)

(21) Appl. No.: 13/253,506

(22) Filed: Oct. 5, 2011

(51) Int. Cl. G06Q 10/06; G06Q 40/06

(52) U.S. Cl. 705/7.28

(57) ABSTRACT

A particular method includes selecting a financial advisor from a plurality of financial advisors. The selected financial advisor has a plurality of financial advising relationships with a plurality of clients. The financial advising relationships are automatically evaluated based on a plurality of risk assessment rules. A relationship risk score for each of the financial advising relationships is computed.

### BACKGROUND

To achieve financial goals, individuals often create relationships with financial advisors. For example, each financial advisor employed or contracted by a financial advising enterprise may have one-to-one relationships with financial planning clients. Each financial advisor may regularly consult with his or her financial planning clients to help the clients achieve their stated financial goals. Financial planners may use computer systems to assist in the financial planning process.

As a financial advising enterprise grows, it may become increasingly difficult to monitor individual financial advisors. As a result, some financial advisors may use deprecated tools and techniques for a considerable amount of time before realizing that newer tools and techniques are available. In addition, when certain financial advisors engage in advising practices that violate enterprise policy or government regulations, such practices may not be systematically noticed and corrected.

### SUMMARY

Systems and methods of quantifying and evaluating risk associated with each financial advising relationship maintained by a financial advisor are disclosed. The financial advising relationships may be evaluated by applying risk assessment rules that are defined by an enterprise. For example, the risk assessment rules may be based on factors including, but not limited to, client age, client valuation, fee schedules, document delivery schedules, and geography. The evaluation process may be fully-automated, such that each financial advisor employed by an enterprise is selected for evaluation at least once during a review cycle (e.g., a calendar year). Alternately, or in addition, high-risk financial advisors may be manually selected or prioritized to be selected for evaluation more often than other financial advisors. The disclosed systems and methods may also provide feedback and remedial options. For example, financial advisors and their supervisors may be provided with feedback in the form of risk assessment reports. Financial advisors may also be provided with a list of recommended and/or mandatory remedial action items that are to be completed.

### BRIEF DESCRIPTION OF THE DRAWINGS

FIG. 1 is a diagram to illustrate a particular embodiment of a system that is operable to perform risk-based evaluation of financial advisors;

FIG. 2 is a diagram to illustrate a particular embodiment of operation of the advisor selection logic of the system of FIG. 1;

FIG. 3 illustrates examples of the risk assessment rules of the system of FIG. 1;

FIG. 4 is a flowchart to illustrate a particular embodiment of a method of performing risk-based evaluation of financial advisors;

FIG. 5 is a flowchart to illustrate another particular embodiment of a method of performing risk-based evaluation of financial advisors;

FIG. 6 illustrates a particular embodiment of an advisor information screen displayed at an advisor review interface that may be generated by the system of FIG. 1;

FIG. 7 illustrates a particular embodiment of a findings summary screen displayed at the advisor review interface that may be generated by the system of FIG. 1; and

FIG. 8 illustrates a particular embodiment of a findings detail screen displayed at the advisor review interface that may be generated by the system of FIG. 1.

### DETAILED DESCRIPTION

In a particular embodiment, a method includes, at a processor of a computing device, selecting a financial advisor from a plurality of financial advisors. The selected financial advisor has a plurality of financial advising relationships with a plurality of clients. The method also includes automatically evaluating the plurality of financial advising relationships based on a plurality of risk assessment rules. The method further includes computing a relationship risk score for each of the financial advising relationships.

In another particular embodiment, a system includes a processor and advisor selection logic executable by the processor to select a financial advisor from a plurality of financial advisors. The selected financial advisor has a plurality of financial advising relationships with a plurality of clients. The system also includes a rules engine executable by the processor to evaluate the plurality of financial advising relationships based on a plurality of risk assessment rules. The system further includes score determination logic executable by the processor to compute a relationship risk score for each of the financial advising relationships.

In another particular embodiment, a non-transitory computer-readable medium includes instructions that, when executed by a computer, cause the computer to select a first subset of financial advisors from a plurality of financial advisors during a first time period. Each financial advisor has a plurality of financial advising relationships with a plurality of clients. The instructions, when executed, also cause the computer to evaluate financial advising relationships of each financial advisor in the first subset of financial advisors based on a plurality of risk assessment rules. The instructions, when executed, further cause the computer to compute relationship risk scores for each of the financial advising relationships of each financial advisor in the first subset of financial advisors. The instructions, when executed, cause the computer to select a second subset of financial advisors from the plurality of financial advisors during a second time period. The instructions, when executed, also cause the computer to evaluate financial advising relationships of each financial advisor in the second subset of financial advisors based on the plurality of risk assessment rules. The instructions, when executed, further cause the computer to compute relationship risk scores for each of the financial advising relationships of each financial advisor in the second subset of financial advisors.

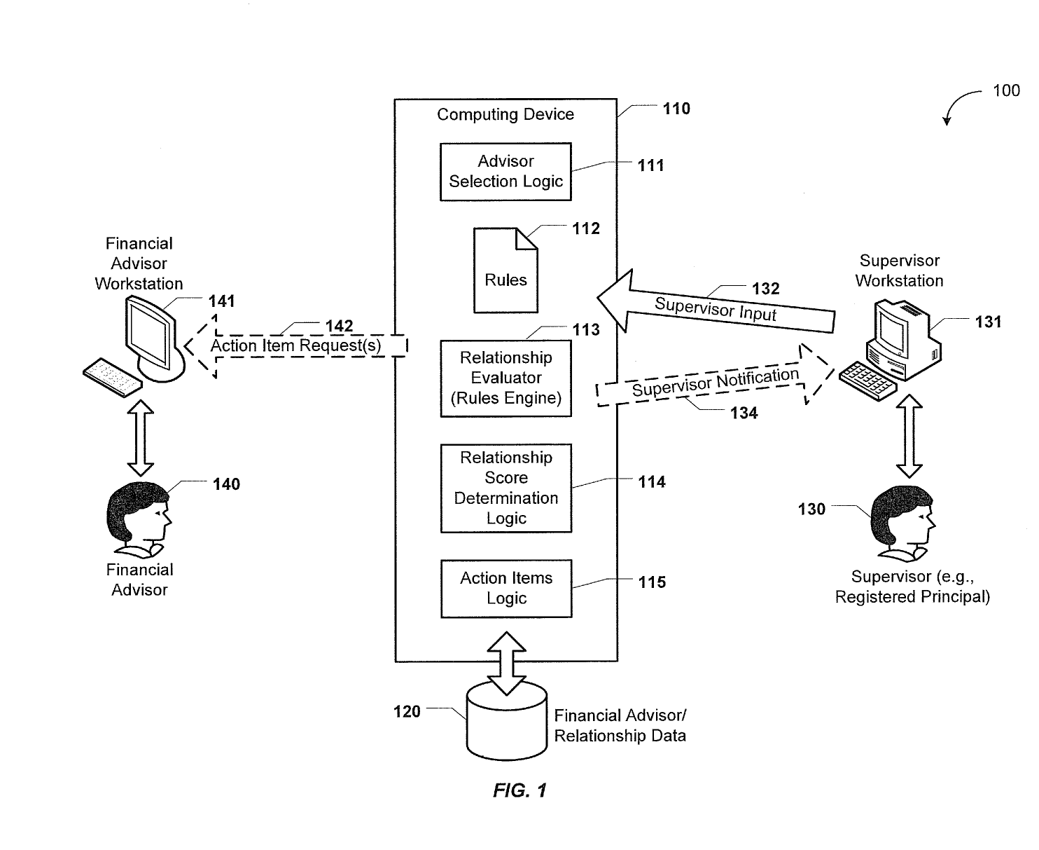

FIG. 1 illustrates a particular embodiment of a system 100 that is operable to perform risk-based evaluation of financial advisors. The system 100 includes a computing device 110 that includes or is communicatively coupled (e.g., via wired and/or wireless network interfaces) to one or more data storage devices or databases configured to store financial advisor and relationship data 120. The computing device 110 (e.g., computer) may also be communicatively coupled to one or more workstations. For example, as illustrated in FIG. 1, the computing device 110 may communicate with a supervisor workstation 131 associated with a supervisor 130 and a financial advisor workstation 141 associated with a financial advisor 140. In a particular embodiment, the supervisor 130 may be a supervisor (e.g., manager) of the financial advisor 140. For example, the supervisor 130 may be a registered principal (e.g., corporate registered principal or field registered principal) or leader at a financial advising enterprise, and the financial advisor 140 may be a financial advisor that is employed or contracted by the financial advising enterprise and that reports to the supervisor 130.

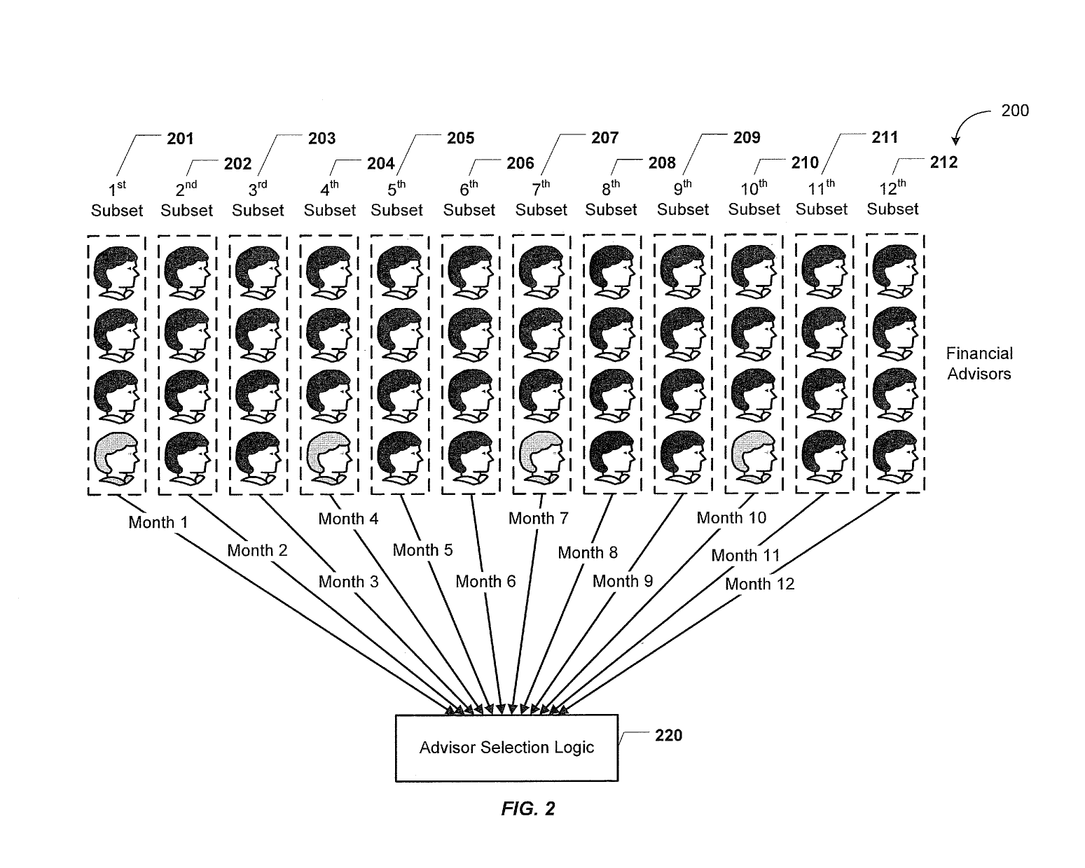

The computing device 110 may include or have access to one or more components that are operable to perform risk-based evaluation of financial advisors. For example, the components may be integrated into an application or tool that is executable by a processor of the computing device 110, where the application or tool is represented by instructions stored at a memory (not shown) of the computing device 110 that are executable by a processor (not shown) of the computing device 110. The computing device 110 may also include input and/or output devices (not shown). The application or tool may be accessible to corporate registered principals, field registered principals, and leaders, but may not be accessible to financial advisors. Components of the application or tool may include advisor selection logic 111 configured to select a plurality of advisors on whom to perform risk evaluation. For example, the advisor selection logic 111 may be configured to automatically and randomly select a subset of the financial advisors employed or contracted by a financial advising enterprise. In a particular embodiment the advisor selection logic 111 is configured to select a subset of financial advisors during each time period (e.g., month of the year), such that each financial advisor is selected at least once during a calendar year or other timeframe regardless of what risk assessment rules are fired for the financial advisor. The subsets of financial advisors may overlap or may be mutually exclusive. Alternately, or in addition, the advisor selection logic 111 may be configured to select financial advisors who have previously been identified as high-risk more often or earlier during the calendar year than low-risk advisors. For example, financial advisors operating in a high-risk geographic area (e.g., due to local laws or media exposure) may be selected more often than other financial advisors. An illustrative example of selecting subsets of financial advisors during a calendar year is further described with reference to FIG. 2.

Each financial advisor may have a plurality of financial advising relationships with a corresponding plurality of financial planning clients. Data representing the financial advising relationships of financial advisors may be accessible to the computing device 110, as illustrated by the stored data 120. Types of financial advising relationships may include, but are not limited to, financial planning (FP) relationships and strategic portfolio service (SPS) relationships. It should be noted that a financial advisor may have multiple relationships with a single client. For example, a financial advisor may have both an FP relationship and an SPS relationship with a single client.

The computing device 110 may also store or have access to a plurality of risk assessment rules 112. The risk assessment rules 112 may be defined by the financial advising enterprise or employees thereof (e.g., by the supervisor 130 via illustrated supervisor input 132). Generally, at least some of the risk assessment rules 112 may represent policies that financial advisors (e.g., the financial advisor 140) are expected to follow. Alternatively, the risk assessment rules 112 may include one or more rules based on factors outside of a financial advisor's control.

The risk assessment rules 112 may be based on various factors. By way of example, and not limitation, the risk assessment rules 112 may include rules based on whether a client's age exceeds a client age threshold and whether a client's valuation (e.g., total net worth) exceeds a client valuation threshold. The risk assessment rules 112 may also include rules regarding fees and fee schedules associated with financial advisors. For example, the risk assessment rules 112 may include rules regarding whether a financial advisor is charging a client a fee that is greater than a maximum total fee threshold or is less than a minimum total fee threshold, or whether a financial advisor is charging a client more than one fee (e.g., one fee for a FP account associated with the client and another fee for an SPS account associated with the client). The risk assessment rules 112 may further include rules based on whether documents, such as financial plans, produced by a financial advisor are “late.” For example, such a rule may be violated when a financial advisor produces a financial plan later than promised to the client (e.g., after a date set in a service agreement agreed upon by the client) or later than when is acceptable under company policy (e.g., a policy indicating that updated financial plans are to be produced each quarter).

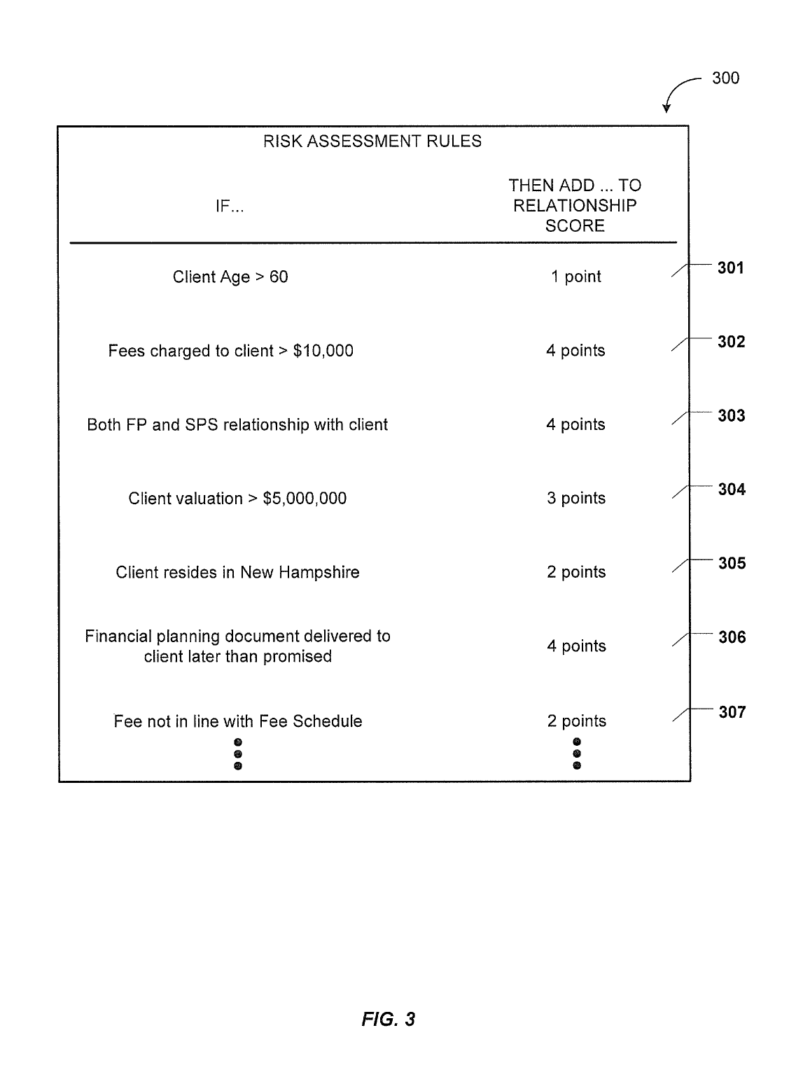

In a particular embodiment, each of the rules 112 has a corresponding point value. Illustrative examples of the risk assessment rules 112, and point values corresponding to each of the risk assessment rules 112, are further described with reference to FIG. 3.

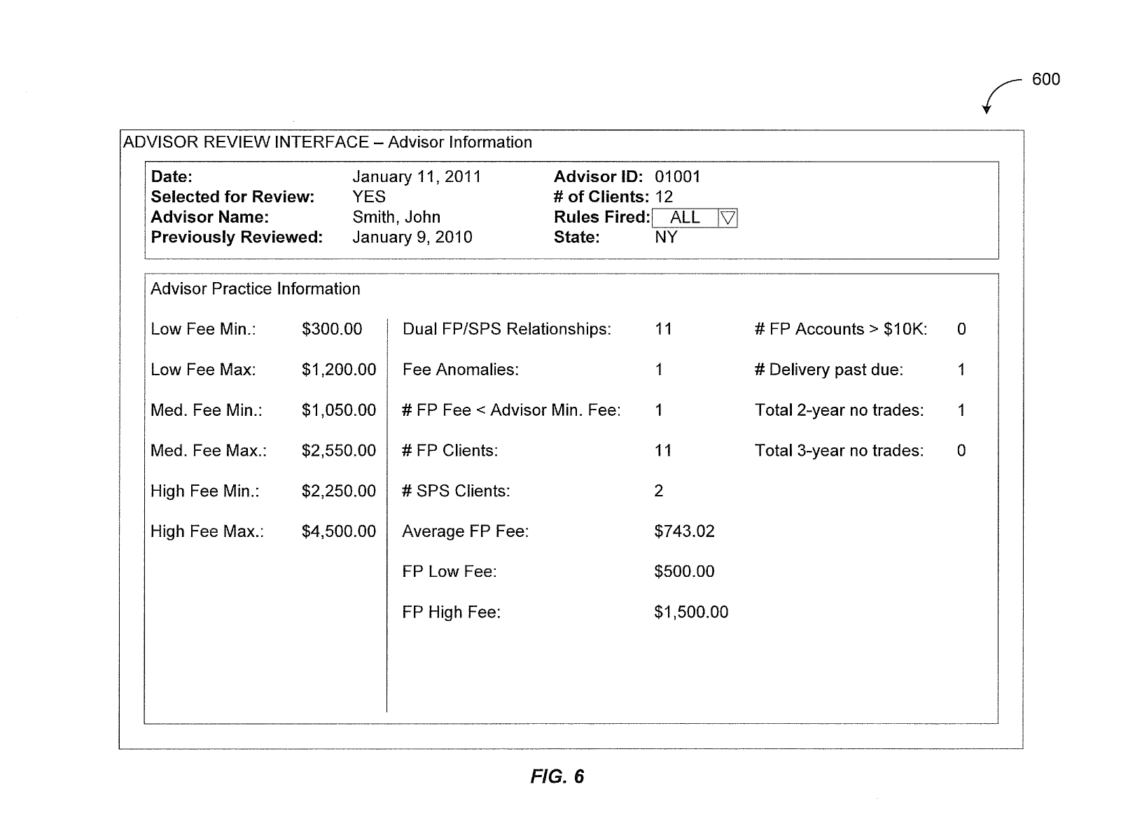

The computing device 110 may include a rules engine 113 that is operable to automatically evaluate financial advising relationships based on the risk assessment rules 112. For example, for each financial advisor in the subset of financial advisors selected by the advisor selection logic 111, the rules engine 113 may evaluate the financial advisor's relationships (as represented by the data 120) against the rules 112. The rules engine 113 may thus generate a list of rules fired against and violated by each financial advising relationship of each financial advisor selected by the advisor selection logic 111. In a particular embodiment, alerts may be generated when a rule is fired. For example, if the financial advisor 140 violates a rule 112 by charging the same fee to more than 50% of his or her financial planning clients, an alert may be generated. The alert may be provided to the supervisor 130 (e.g., registered principal). For example, a note may appear in an advisor information screen (e.g., the advisor information screen further described with reference to FIG. 6) to alert the supervisor.

The computing device may also include relationship score determination logic 114. The logic 114 may compute a relationship risk score for each financial advising relationship evaluated by the rules engine 113. For example, when each of the risk assessment rules is associated with a corresponding point value, the relationship risk score of a particular relationship may be equal to a sum of the point values associated with rules that are violated by the particular relationship. To illustrate, if a financial advisor has two relationships, and each relationship violates a rule worth three points, each relationship would have a relationship risk score of three.

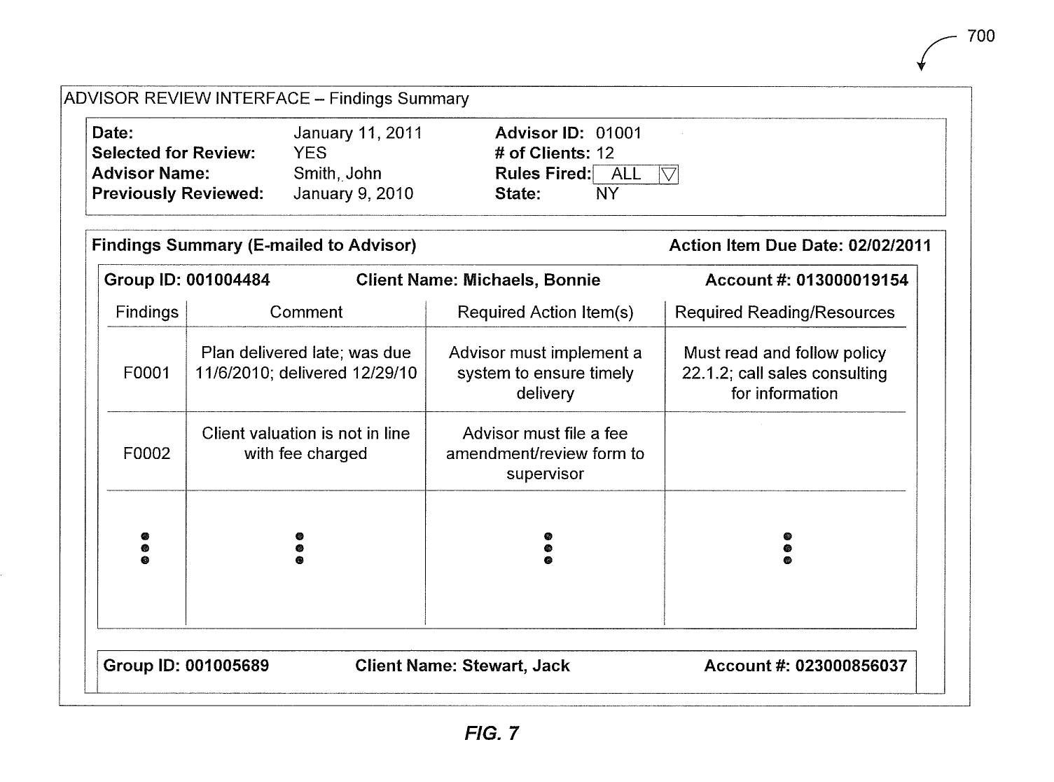

The computing device 110 may further include action items logic 115. The action items logic 115 may determine, for each evaluated financial advisor, whether action item requests 142 are to be sent to the financial advisor 140 (i.e., to the computing device or workstation 141 associated with the financial advisor 140). To illustrate, the action items logic 115 may automatically (or in conjunction with input 132 from the supervisor 130) generate and transmit the action item requests 142 to the financial advisor 140 (or the workstation 141 associated therewith). Alternately, the determination whether or not to transmit such action item requests 142 may be performed by an entity that is separate from the computing device 110 (e.g., by a centralized supervision unit of an enterprise). In one example, the action item requests 142 may include pre-populated information regarding remedial actions, as further described with reference to FIG. 7. In a particular embodiment, even when no action item requests 142 are sent to the financial advisor 140, the financial advisor 140 may receive a notification that the financial advisor 140 was reviewed (e.g., an e-mail notification may be sent to the financial advisor workstation 141). In a particular embodiment, an advisor review tool may provide an automated method for the supervisor 130 to notify the financial advisor 140 that he/she has been reviewed (e.g., a notification facilitated by an e-mail application or framework).

Each of the action item requests 142 may be associated with a remedial risk mitigation action that is recommended or required to be performed by the financial advisor 140. For example, if the financial advisor 140 has missed numerous deadlines, the financial advisor 140 may be transmitted an action item request requiring that the financial advisor review financial planning deadlines and calendar policies. Each of the action item requests 142 may also have an associated due date.

In a particular embodiment, a notification 134 indicating that the financial advisor 140 has been classified as high-risk may first be transmitted to the supervisor workstation 131. It will be noted that the action item request(s) 142 and the supervisor notification 134 are depicted using dashed lines in FIG. 1 because they may not be present or may be optional depending on implementation and results of the rules engine 113. In a particular embodiment, the supervisor 130 may review the notification 134 and may provide the input 132, which may be used by the action items logic 115 to create the action item requests 142. To illustrate, the input 132 may indicate that the supervisor 130 is available to meet with the financial advisor 140 in two weeks. Based on the input 132, the action items logic 115 may set each of the action item requests 142 to be due two weeks in the future.

During operation, the advisor selection logic 111 may select one or more financial advisors that will be subjected to risk-based evaluation. For example, the advisor selection logic 111 may select the financial advisor 140. The rules engine 113 may retrieve data 120 representing the various financial advising relationships of the financial advisor 140 and may evaluate the relationships based on the risk assessment rules 112. The relationship score determination logic 114 may determine which rules 112 fire for the selected financial advisor 140 and, in one example, may also compute risk scores for each financial advising relationship of the financial advisor 140. Depending on the results of the rules engine 113, the action item requests 142 and/or an e-mail notification indicating that the financial advisor 140 has been reviewed may be transmitted to the financial advisor workstation 141. As another option, reports that include advisor risk scores (individually or in aggregate) may be distributed periodically or in as-requested reports.

During operation of the system 100, various graphical user interfaces may be generated and/or displayed by the computing device 110 and the supervisor workstation 131. For example, an advisor review interface may be generated and displayed, as further described with reference to FIGS. 6-8.

It should be noted that although FIG. 1 illustrates the computing device 110 and the supervisor workstation 131 as separate and located remote to each other, one or more of the devices may be integrated. For example, components of the computing device 110 may be integrated into the supervisor workstation 131, thereby enabling the supervisor 130 to perform risk-based evaluation of financial advisors from the supervisor workstation 131.

The system 100 of FIG. 1 may thus enable risk-based evaluation of financial advisors and individual client advising relationships of the financial advisors and may provide convenient “snapshot” interfaces of risk assessment (as further illustrated with reference to FIGS. 6-8). Additionally, the system 100 of FIG. 1 may enable targeted selection of high-risk financial advisors for evaluation. Since low-risk advisors may not need additional supervision or action item recommendations, selective targeting of high-risk financial advisors may lead to an overall time savings in the review process. Alternately, or in addition, the system 100 of FIG. 1 may be programmed such that every advisor is reviewed at least once during a review cycle (e.g., calendar year), regardless of whether and how many rules fire for the advisor. The system 100 of FIG. 1 may thus provide an improved advice review process when compared to systems that either randomly select relationships for review or that review every advisor during every review period of a review cycle.

FIG. 2 illustrates a particular embodiment of advisor selection and is generally designated 200. FIG. 2 includes advisor selection logic 220, which in an illustrative embodiment may be the advisor selection logic 111 of FIG. 1. In a particular embodiment, the advisor selection logic 220 may be implemented using instructions that are stored at a memory of a computing device (e.g., the computing device 110 of FIG. 1) and executable by a processor of the computing device.

The advisor selection logic 220 may select, during each advisor review period, a subset of financial advisors to be reviewed. In a particular embodiment, the advisor selection logic 220 may divide the available universe of financial advisors into mutually exclusive, non-overlapping subsets. For example, the advisor selection logic 220 may divide the financial advisors into twelve subsets 201-212, where each subset of financial advisors is reviewed during a particular month of the year.

Alternately, or in addition, the advisor selection logic 220 may prioritize advisors that are deemed to be high-risk, associated with predetermined high-risk conditions, and/or have the potential to be high risk (e.g., due to the types of clients the advisors serve, the geographic region where the advisors are located, increased media visibility, etc.) for earlier or more frequent selection. For example, such high-risk financial advisors may be indicated in gray in FIG. 2, and may be selected for review quarterly instead of once per year.

Thus, the advisor selection logic 220 of FIG. 2 may be programmed to select advisors as frequently or as infrequently as desired by an enterprise, in accordance with the enterprise's review policies.

FIG. 3 illustrates particular examples of risk assessment rules 300. In an illustrative embodiment, one or more of the risk assessment rules 300 of FIG. 3 may be included in the risk assessment rules 112 of FIG. 1. It should be noted that the rules 300 of FIG. 3 are for illustration only, and other types of rules may be used in conjunction with the advisor review techniques disclosed herein.

In a particular embodiment, as illustrated in FIG. 3, each rule may be associated with a corresponding point value. In such an embodiment, the risk score for a relationship may be computed as the sum of point values of rules that are violated by the relationship.

To illustrate, the rules 300 include a first rule 301 indicating that if the age of a client associated with a relationship is greater than sixty, then the risk score for the relationship is to be incremented by 1 point. A second rule 302 indicates that if the financial advisor charges a client more than $10,000 in fees, then the risk score for the relationship is to be incremented by 4 points. A third rule 303 indicates that if the financial advisor has both a financial planning (FP) relationship and a strategic portfolio services (SPS) relationship with the client, then the risk score for the relationship is to be incremented by 4 points. It will be appreciated that the third rule 303 may fire for both the FP relationship and the SPS relationship, thus contributing a total of 8 points to the advisor's overall risk score. In an alternate embodiment, the rule 303 may fire for only one of the relationships and may contribute only 4 points.

A fourth rule 304 indicates that if the valuation (e.g., overall net worth, total money invested in accounts managed by the financial advisor, or some other valuation metric) of the client is greater than $5,000,000, then the risk score for the relationship is to be incremented by 3 points. A fifth rule 305 indicates that if the client resides in a particular geographic region (e.g., New Hampshire in FIG. 3), then the risk score for the relationship is to be incremented by 2 points. A sixth rule 306 indicates that if the advisor delivers a financial planning document to the client later than promised, then the risk score for the relationship is to be incremented by 4 points.

A seventh rule 307 indicates that if the financial advisor charges the client a fee that exceeds a fee schedule (e.g., a suggested, recommended, or approved fee schedule), then the risk score for the relationship is to be incremented by 2 points.

It should be noted that the various thresholds and specifics (e.g., 60 years of age, fees of $10,000, state of New Hampshire, etc.), as well as the point values and the differences in point values, depicted in FIG. 3 are provided for illustration only. Risk assessment rules may be defined using various thresholds, specifics, and relative point values in accordance with an enterprise's policies.

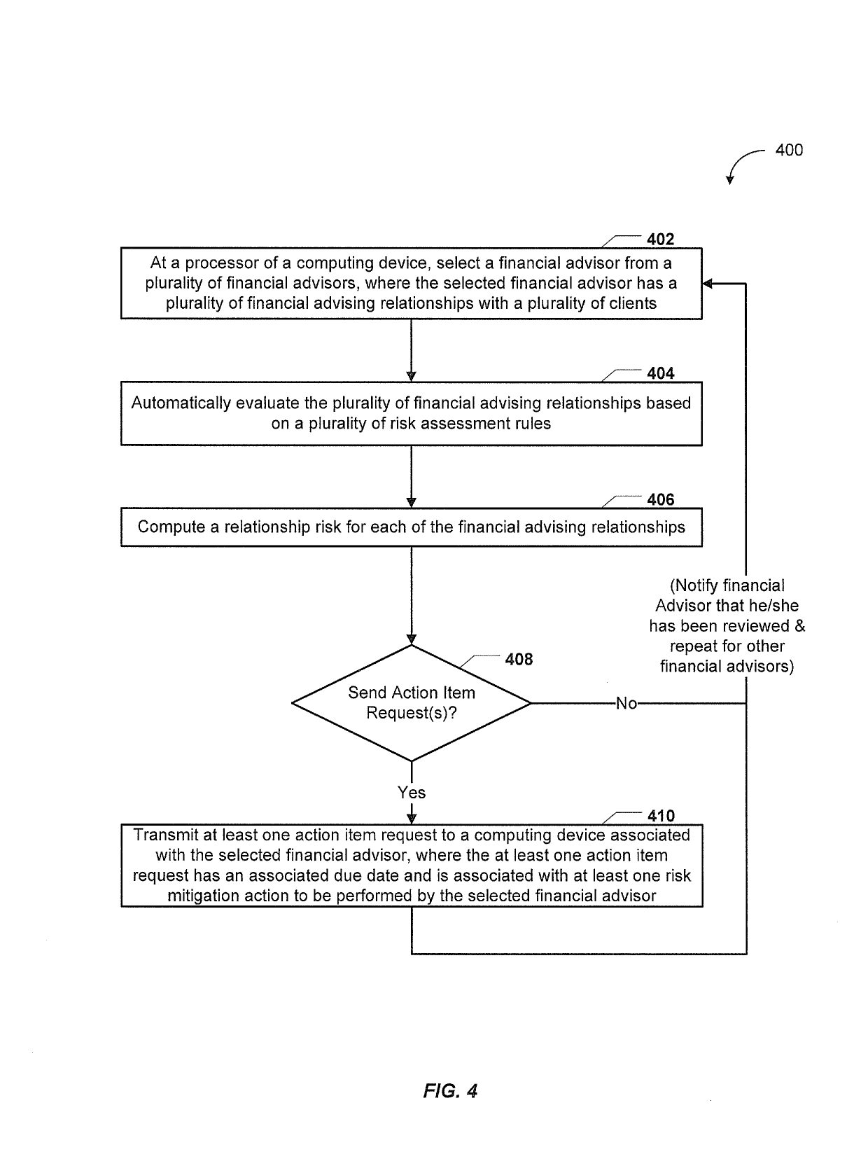

FIG. 4 is a flowchart to illustrate a particular embodiment of a method 400 of performing risk-based evaluation of financial advisors. In an illustrative embodiment, the method 400 may be performed by the system 100 of FIG. 1.

The method 400 may be performed by a processor of a computing device and may include selecting a financial advisor from a plurality of financial advisors, at 402. The selected financial advisor may have a plurality of financial advising relationships with respect to a corresponding plurality of clients. For example, in FIG. 1, the advisor selection logic 111 may select the financial advisor 140, where the financial advisor has advising relationships with a plurality of clients, and where data regarding the relationships is stored at the financial advisor and relationship data 120.

The method 400 may also include automatically evaluating the plurality of financial advising relationships based on a plurality of risk assessment rules, at 404. For example, in FIG. 1, the rules engine 113 may automatically evaluate the relationships of the financial advisor 140 based on the risk assessment rules 112.

The method 400 may further include computing a relationship risk for each of the financial advising relationships, at 406. For example, in FIG. 1, the relationship score determination logic 114 may compute relationship risk scores for each relationship of the financial advisor 140.

The method 400 may include determining whether or not to send action item request(s) to the financial advisor, at 408. The determination may be automatic, at least partially based on user input (e.g., from a supervisor or a registered principal), or may be fully based on user input. When it is determined that the action item request(s) are not to be sent, the method 400 may include notifying the financial advisor that he/she has been reviewed and may return to 402 to evaluate other financial advisors.

When it is determined that the action item request(s) are to be sent, the method 400 may include transmitting at least one action item request to a computing device associated with the selected financial advisor, at 410. The at least one action item request may have an associated due date and may be associated with at least one risk mitigation action to be performed by the selected financial advisor. In a particular embodiment, the action item request(s) may be transmitted by a centralized supervision unit. Alternately, as illustrated in FIG. 1, the action items logic 115 may transmit the action item request(s) 142 to the financial advisor work station 141 associated with the financial advisor 140.

In a particular embodiment, depending on the types of risk assessment rules triggered (e.g., rules violated by a financial advising relationship), information regarding the relationship may automatically be forwarded (e.g., by the action items logic 115 of FIG. 1) to a computing device associated with a sales practice supervisor. In another particular embodiment, after a supervisor has been notified of a financial advisor's risk evaluation and after the financial advisor has received notice of action items to be completed, the supervisor and the financial advisor may engage in a follow-up process. (not shown in FIG. 4). For example, the financial advisor and the supervisor may communicate and/or attend in-person meetings to review the financial advisor's risk assessment and the financial advisor's progress in completing the action items. When all of the action items are completed, the supervisor may mark the financial advisor's review as “closed” or “complete.” Alternately, if the financial advisor misses the due dates for the action items, the supervisor may submit the financial advisor's review to an escalation process. The follow-up process, including feedback communication, scheduling of meetings, and potential escalation, and user interfaces associated therewith, may also be provided by an advice review system configured to perform the method 400 of FIG. 4, such as the system 100 of FIG. 1.

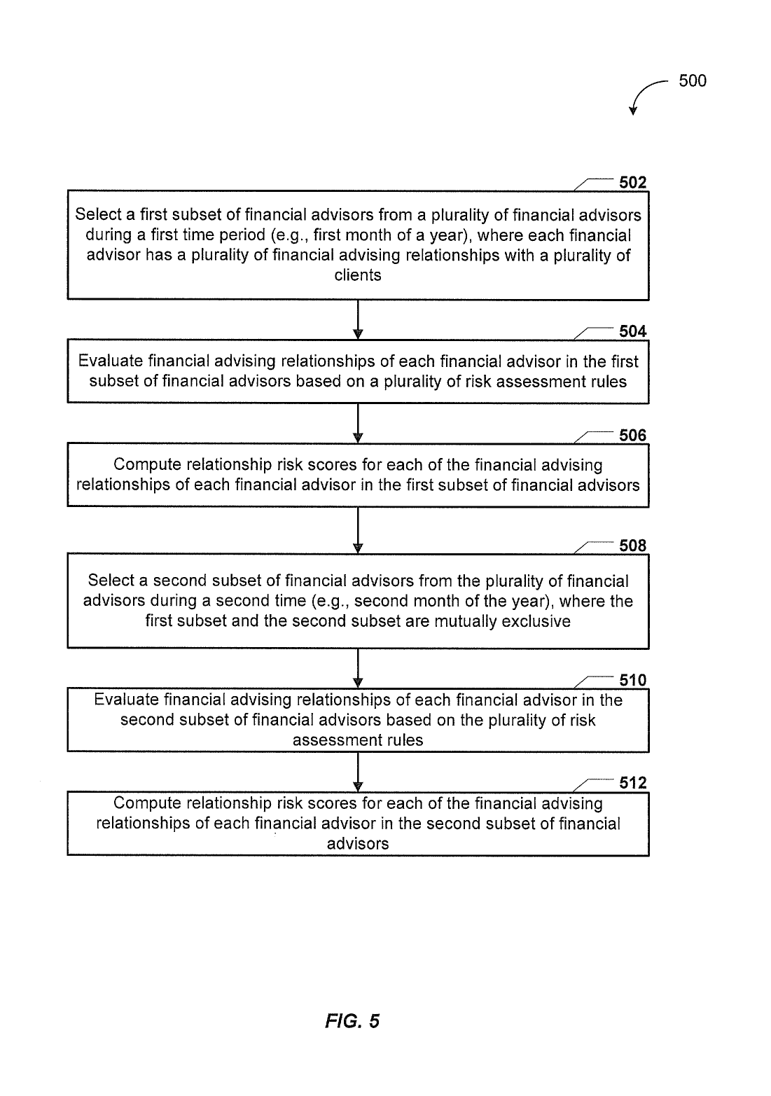

FIG. 5 is a flowchart to illustrate another particular embodiment of a method 500 of performing risk-based evaluation of financial advisors. In an illustrative embodiment, the method 500 may be performed by the system 100 of FIG. 1.

The method 500 may include selecting a first subset of financial advisors from a plurality of financial advisors during a first time period (e.g., a first month of a year), at 502. Each financial advisor may have a plurality of financial advising relationships with a plurality of clients. For example, in FIG. 1, the advisor selection logic 111 may select a first subset of financial advisors. As illustrated in FIG. 2, the first subset of financial advisors may be one of the subsets 201-212.

The method 500 may also include evaluating financial advising relationships of each financial advisor in the first subset of financial advisors based on a plurality of risk assessment rules, at 504. For example, in FIG. 1, the rules engine 113 may evaluate the relationships of each financial advisor in the first subset of financial advisors based on the risk assessment rules 112.

The method 500 may further include computing relationship risk scores for each of the financial advising relationships of each financial advisor in the first subset of financial advisors, at 506. For example, in FIG. 1, the relationship score determination logic 114 may compute relationship risk scores for each relationship of each advisor in the first subset of financial advisors.

The method 500 may include selecting a second subset of financial advisors from a plurality of financial advisors during a second time period (e.g., a second month of a year), at 508. For example, in FIG. 1, the advisor selection logic 111 may select a second subset of financial advisors. As illustrated in FIG. 2, the second subset of financial advisors may be another of the subsets 201-212.

The method 500 may also include evaluating financial advising relationships of each financial advisor in the second subset of financial advisors based on the plurality of risk assessment rules, at 510. For example, in FIG. 1, the rules engine 113 may evaluate the relationships of each financial advisor in the second subset of financial advisors based on the risk assessment rules 112.

The method 500 may further include computing relationship risk scores for each of the financial advising relationships of each financial advisor in the second subset of financial advisors, at 512. For example, in FIG. 1, the relationship score determination logic 114 may compute relationship risk scores for each relationship of each advisor in the second subset of financial advisors.

The method 500 may thus enable periodic risk-based evaluation of financial advisors and individual client advising relationships of the financial advisors. The method 500 of FIG. 5 may provide an improved advice review process when compared to methods that either randomly select relationships for review or that review every advisor during every review period of a review cycle.

FIG. 6 illustrates a particular embodiment of an advisor information screen displayed at an advisor review interface and is generally designated 600. For example, the advisor information screen 600 may be generated and/or displayed at the computing device 110 of FIG. 1 and/or the supervisor workstation 131 of FIG. 1.

As illustrated in FIG. 6, the advisor information screen 600 may represent a “snapshot” of a particular financial advisor's practice, including details regarding the financial advisor and a summary of the advising relationships maintained by the financial advisor. For example, in FIG. 6, the advisor information screen 600 includes details regarding an advisor John Smith, who has been selected for review on or prior to Jan. 11, 2011 and who was last reviewed on Jan. 9, 2010. The selected advisor resides in the state of New York and has 12 clients. The advisor information screen 600 also includes various statistics regarding the advisor's relationships, such as fee ranges, maximum fees charged, minimum fees charged, average fees charged, how many accounts have been inactive (e.g., no stock/fund/bond trades have been performed) for two years, and how many accounts have been inactive for three years. The advisor information screen 600 may be displayed to a supervisor of John Smith (e.g., in accordance with the systems and methods described herein).

FIG. 7 illustrates a particular embodiment of a findings summary screen displayed at an advisor review interface and is generally designated 700. For example, the findings summary screen 700 may be generated and/or displayed at the computing device 110 of FIG. 1 and/or the supervisor workstation 131 of FIG. 1.

As illustrated in FIG. 7, the findings summary screen 700 may include details regarding a reviewed financial advisor and may include a findings summary that is to be e-mailed or otherwise sent to the selected financial advisor (e.g., as part of the action item requests 142 of FIG. 1). In a particular embodiment, the findings summary may be organized by client, and findings for each client may explain what risk assessment rules were triggered by the relationship with the client. The findings summary may also include a list of associated action items to be completed and reading/resources available to the financial advisor, as depicted in FIG. 7. In a particular embodiment, information included in the findings summary is pre-populated and registered principals are required to use the pre-populated information. For example, the pre-populated information can be represented via a gap matrix (e.g., spreadsheet) that is coded into (i.e., built into) an advisor review tool. Registered principals use a pre-populated gap to record a finding from the review. The matrix may include, for each gap (i.e., advisor/relationship deficiency), a gap description, follow-up or gap closure actions to be performed by the advisor, a number of days until due, and other information. By pre-populating such information (e.g., at an enterprise level), consistency may be maintained between various corporate registered principals that are responsible for advisor reviews. In a particular embodiment, once a corporate registered principal selects a gap, they may add to and/or selectively modify the gap information, thereby personalizing the information to the particular client relationship or advisor being reviewed.

In FIG. 7, the findings summary for the selected advisor John Smith includes findings with respect to at least two clients: Bonnie Michaels and Jack Stewart. The relationship with the client Bonnie Michaels has been found to violate two rules, corresponding to findings F0001-F0002, where each finding has an associated required action item(s) and/or required reading/resources.

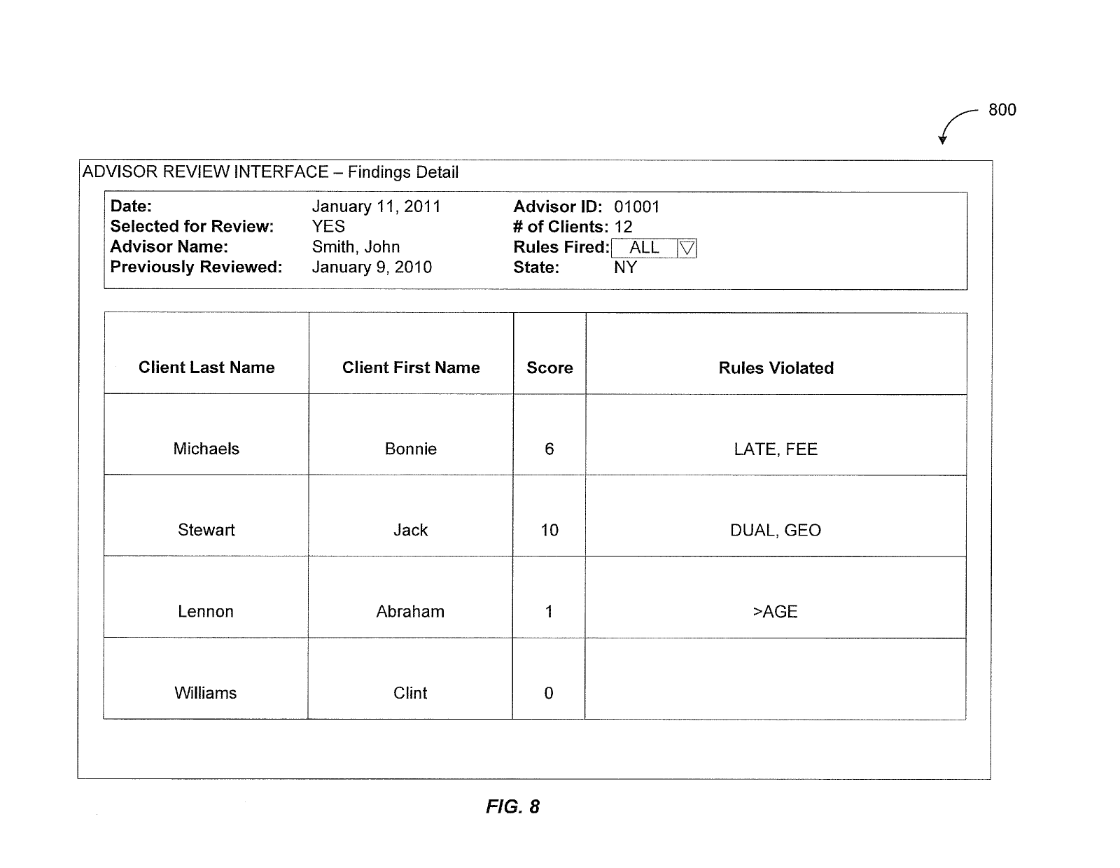

FIG. 8 illustrates a particular embodiment of a findings detail screen displayed at an advisor review interface and is generally designated 800. For example, the findings detail screen 800 may be generated and/or displayed at the computing device 110 of FIG. 1 and/or the supervisor workstation 131 of FIG. 1.

The findings detail screen 800 may list the computed relationship risk score for each of John Smith's advising relationships and may also list the rules triggered by (e.g., rules determined to apply to) each relationship.

For example, as illustrated in FIG. 8, the relationship with Bonnie Michaels is computed to have a relationship risk score of 6, due to the rules abbreviated LATE (e.g. the sixth rule 306 of FIG. 3, which adds 4 points to the relationship risk score when a financial planning document is delivered late) and FEE (e.g., the seventh rule 307 of FIG. 3, which adds 2 points to the relationship risk score when the fee charged to the client is not in line with an approved fee schedule).

Further, the relationship with Jack Stewart is computed to have a relationship risk score of 10. The relationship with Jack Stewart triggered the rule DUAL (e.g., the third rule 303 of FIG. 3, which adds 4 points to the relationship risk score when the financial advisor has both an FP and an SPS relationship with the client). Thus, the selected financial advisor John Smith may have two relationships with the client Jack Stewart, and the findings detail screen 800 of FIG. 8 may consolidate the information for both relationships into a single row. In an alternate embodiment, the relationships may be listed in separate rows, where one relationship has a score of 4 due to the rule DUAL, and the other relationship has a score of 6, due to the rules DUAL and FEE (e.g., the tenth rule 310 of FIG. 3, which adds 2 points to the relationship risk score when the fee charged to the client is not in line with an approved fee schedule).

In addition, the relationship with client Abraham Lennon has a relationship risk score of 1 due to the rule >AGE (e.g., the first rule 301 of FIG. 1, which adds 1 point to the relationship risk score if the client's age is greater than sixty). The relationship with the client Clint Williams has a relationship risk score of 0, indicating that the relationship was not found to have triggered any risk assessment rules.

It will be appreciated that the graphical user interface screens illustrated in FIGS. 6-8 may provide convenient visual encapsulations of the advice review process (or information relating thereto), including practice information regarding a selected advisor, information regarding individual advising relationships, and information regarding rules found to have been triggered during the review process. Such interfaces and screens may be generated by one or more applications executed at the computing device 110 of FIG. 1 and/or the supervisor workstation 131 of FIG. 1. The computing device 110 of FIG. 1 and the supervisor workstation 131 of FIG. 1 may also be operable to transmit data representing the interfaces and screens via wired or wireless networks.

Although the exemplary embodiments described herein are intended to enable a person skilled in the art to practice such embodiments, it should be understood that other embodiments may be realized and that logical and physical changes may be made without departing from the scope of the present disclosure. Thus, the detailed description herein is presented for purposes of illustration only and not for limitation.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

In one embodiment, portions of the present disclosure may be implemented using a system that includes a software module, logic engines, computer hardware, databases, and/or computer networks. Moreover, while the description may make reference to specific technologies, system architectures, and data management techniques, it will be appreciated that other devices and/or methods that use different technologies, architectures, or techniques may be implemented without departing from the scope of the disclosure. Similarly, while the description may make reference to web clients, personal computers, and servers, it will be appreciated that other embodiments may include implementations using point of service (POS) devices, kiosks, handheld devices such as personal digital assistants and cellular telephones, or other devices. This disclosure is intended to cover any and all subsequent adaptations or variations of various embodiments.

The provided Abstract is not intended to be used in interpreting or limiting the scope or meaning of the claims. In addition, the disclosure is not to be interpreted as indicating that the claimed embodiments require more features than are expressly recited in each claim. Thus, the present disclosure is not intended to be limited to the embodiments shown herein but is to be accorded the widest scope possible consistent with the principles and novel features as defined by the following claims.

1. A method comprising:
selecting, using a processor of a computing device, a financial advisor from a plurality of financial advisors, wherein the selected financial advisor has a plurality of financial advising relationships with a plurality of clients, the plurality of financial advising relationships established prior to selection of the financial advisor;
automatically evaluating, using the processor of the computing device, the plurality of financial advising relationships based on a plurality of risk assessment rules; and
computing, using the processor of the computing device, a relationship risk score for each of the financial advising relationships.

2. The method of claim 1, further comprising:
transmitting at least one action item request to a computing device associated with the selected financial advisor.

3. The method of claim 2, wherein the at least one action item request has an associated due date and is associated with at least one risk mitigation action to be performed by the selected financial advisor.

4. The method of claim 2, wherein the at least one action item request is generated by a computing device associated with a supervisor of the selected financial advisor, wherein the computing device associated with the supervisor is configured to generate an advisor review interface to display practice information for the selected financial advisor.

5. The method of claim 2, wherein the at least one action item request is automatically generated, and further comprising transmitting a notification regarding the at least one action item request to a computing device associated with a supervisor of the selected financial advisor.

6. The method of claim 1, wherein the plurality of financial advising relationships includes at least one financial planning (FP) relationship, at least one strategic portfolio service (SPS) relationship, or any combination thereof.

7. The method of claim 1, wherein the plurality of risk assessment rules includes at least one rule based on a client age exceeding a client age threshold, a client valuation exceeding a client valuation threshold, or any combination thereof.

8. The method of claim 1, wherein the plurality of risk assessment rules includes at least one rule based on a fee charged by the selected financial advisor exceeding a total fee threshold, exceeding a fee schedule associated with the selected financial advisor, or any combination thereof.

9. The method of claim 1, wherein the plurality of risk assessment rules includes at least one rule based on whether a document produced by the selected financial advisor is late with respect to a delivery schedule associated with the selected financial advisor.

10. The method of claim 1, wherein each of the plurality of financial advising relationships is evaluated based on the plurality of risk assessment rules at an advice review tool that is accessible to corporate registered principals and field registered principals but is not accessible to financial advisors.

11. The method of claim 1, wherein each of the plurality of risk assessment rules is associated with a corresponding point value and wherein the relationship risk score for each financial advising relationship is equal to a sum of point values associated with risk assessment rules that are triggered by the financial advising relationship.

12. The method of claim 1, further comprising:
during a first time period, selecting a first subset of financial advisors from the plurality of financial advisors;
evaluating risk associated with financial advising relationships of each financial advisor in the first subset of financial advisors;
during a second time period, selecting a second subset of financial advisors from the plurality of financial advisors; and
evaluating risk associated with financial advising relationships of each financial advisor in the second subset of financial advisors.

13. The method of claim 1, further comprising
evaluating a particular financial advising relationship between a particular financial advisor and a particular client at a first time; and
reevaluating the particular financial advising relationship between the particular financial advisor and the particular client at a second time that is subsequent to the first time.

14. (canceled)

15. A system, comprising:
a processor; and
a memory storing instructions executable by the processor to:
select a financial advisor from a plurality of financial advisors, wherein the selected financial advisor has a plurality of financial advising relationships with a plurality of clients, the plurality of financial advising relationships established prior to selection of the financial advisor;
evaluate the plurality of financial advising relationships based on a plurality of risk assessment rules; and
compute a relationship risk score for each of the financial advising relationships.

16. The system of claim 15, wherein the selected financial advisor is selected randomly and wherein each of the plurality of financial advisors is selected at least once during a year.

17. The system of claim 15, wherein the memory further stores instructions executable by the processor to prioritize selection of financial advisors that are associated with one or more high-risk conditions.

18. The system of claim 15, further comprising a storage device configured to store data associated with at least one of the plurality of financial advising relationships.

19. A non-transitory computer-readable medium comprising instructions that, when executed by a computer, cause the computer to:
select a first subset of financial advisors from a plurality of financial advisors during a first time period, wherein each financial advisor has a plurality of financial advising relationships with a plurality of clients, the plurality of financial advising relationships established prior to selection of the financial advisor;
evaluate financial advising relationships of each financial advisor in the first subset of financial advisors based on a plurality of risk assessment rules;
compute relationship risk scores for each of the financial advising relationships of each financial advisor in the first subset of financial advisors;
select a second subset of financial advisors from the plurality of financial advisors during a second time period;
evaluate financial advising relationships of each financial advisor in the second subset of financial advisors based on the plurality of risk assessment rules; and
compute relationship risk scores for each of the financial advising relationships of each financial advisor in the second subset of financial advisors.

20. The non-transitory computer-readable medium of claim 19, wherein the first subset of financial advisors and the second subset of financial advisors are mutually exclusive.
